(19) United States
(12) Patent Application Publication
(10) Pub. No.: US 2007/0069809 A1
(43) Pub. Date: Mar. 29, 2007

(54) Internal voltage generator

(75) Inventor: Khil-Ohk Kang, Kyoungki-do (KR)

Correspondence Address: MCDERMOTT WILL & EMERY LLP, 600 13TH STREET, N.W., WASHINGTON, DC, 20005-3096, US

(73) Assignee: HYNIX SEMICONDUCTOR INC.

(21) Appl. No.: 11/529,257

(22) Filed: Sep. 29, 2006

(30) Foreign Application Priority Data
Sep. 29, 2005 (KR) 2005-0091567
Apr. 28, 2006 (KR) 2006-0038699

(51) Int. Cl. G05F 1/10

(52) U.S. Cl. 327/541

(57) ABSTRACT

An internal voltage generator includes a voltage comparator operating in response to an enable signal, comparing a reference voltage with a feedback voltage and outputting a comparison signal through a first node. A driving controller outputs a drive control signal in response to the comparison signal. An output driver outputs an internal voltage through a second node in response to the drive control signal. An initial operation stabilizer controls the driving controller for a certain period at which the enable signal is enabled to block an output of the drive control signal.

### FIELD OF THE INVENTION

The present invention relates to a semiconductor memory device, and more particularly, to an internal voltage generator of a semiconductor memory device.

### BACKGROUND

In general, as semiconductor memory devices have become more highly integrated, sizes of cells have been scaled down, further resulting in low operation voltage. In dynamic random access memories (DRAMs), internal voltages are generated after an external power supply voltage is supplied. The external power supply voltage has a voltage level which may be variable depending on various factors including noise. Thus, it is necessary to develop an internal voltage generator that can stably generate an internal voltage even though the external power supply voltage is fluctuated.

FIG. 1 is a block diagram of a conventional internal voltage generator of a DRAM.

A reference voltage generator 20 generates a reference voltage VREF using an external power supply voltage VDD. The internal voltage generator 40 is supplied with the reference voltage VREF and generates an internal voltage INT_VOL using the external power supply voltage VDD. The internal voltage INT_VOL is used to operate an internal circuit block 60.

FIG. 2 is a circuit diagram of the internal voltage generator 40 illustrated in FIG. 1.

The internal voltage generator 40 includes a voltage comparator 42, a precharge block 44, a driving controller 46, an output driver 47, and a voltage divider 48.

The voltage divider 48 includes two resistors Rl and R2 that are connected in series between an output voltage terminal and a terminal of a ground voltage VSS. The voltage divider 48 divides the internal voltage INT_VOL. A voltage divided from the internal voltage INT_VOL, i.e., a feedback voltage HALF, is supplied to the voltage comparator 42.

The voltage comparator 42 includes first to third N-type channel metal-oxide semiconductor (NMOS) transistors N1, N2 and N3, and first and second P-type channel metal-oxide semiconductor (PMOS) transistors P1 and P2, which form a current mirror circuit. The first NMOS transistor N1 is connected between a node D and the terminal of the ground voltage VSS, and an enable signal IN is input to a gate of the first NMOS transistor N1. The second NMOS transistor N2 is connected between a node C and the node D, and the feedback voltage HALF is supplied to a gate of the second NMOS transistor N2. The third NMOS transistor N3 is connected between a node A and the node D, and the reference voltage VREF is supplied to a gate of the third NMOS transistor N3. The first PMOS transistor P1 is connected between a terminal of the power supply voltage VDD and the node C, and a gate of the PMOS transistor P1 is connected to the node A. The second PMOS transistor P2 is connected between the terminal of the power supply voltage VDD and the node A, and a gate of the second PMOS transistor P2 is connected to the node A. The voltage comparator 42 compares the reference voltage VREF with the internal voltage INT_VOL. If the feedback voltage HALF has a voltage level less than the reference voltage VREF, the third NMOS transistor N3 causes a larger amount of current flow as compared with the second NMOS transistor N2, and a voltage level of the node A is lowered. If the feedback voltage HALF has a voltage level greater than the reference voltage VREF, the second NMOS transistor N2 causes a larger amount of current flow as compared with the third NMOS transistor N3, and a voltage level of the node C is lowered. A signal provided after the comparison is input to the driving controller 46.

The driving controller 46 includes third and fourth PMOS transistors P3 and P4 and fourth and fifth NMOS transistors N4 and N5. The third PMOS transistor P3 is connected between a node E and the terminal of the power supply voltage VDD, and a gate of the third PMOS transistor P3 is connected to the node C. The fourth PMOS transistor P4 is connected between the terminal of the power supply voltage VDD and one terminal of the fourth PMOS transistor P4, and a gate of the fourth PMOS transistor P4 is connected to the node A. The fourth NMOS transistor N4 is connected between another terminal of the fourth PMOS transistor P4 and the terminal of the ground voltage VSS, and one terminal of the fourth NMOS transistor N4 is connected to a gate thereof. The fifth NMOS transistor N5 is connected between the node E and the terminal of the ground voltage VSS, and the gate of the fourth NMOS transistor N4 is connected to a gate of the fifth NMOS transistor N5. The driving controller 46 outputs a signal that controls the output driver 47. When an amount of current flowing to the node A decreases, an amount of current flowing through the fifth NMOS transistor N5 of the driving controller 46 increases. As a result, a voltage level of the node E decreases. When an amount of current flowing through the node C increases, the third PMOS transistor P3 turns on. As a result, the voltage level of the node E increases.

The output driver 47 includes a fifth PMOS transistor P5 connected between the output node X of the internal voltage generator 40 and the terminal of the power supply voltage VDD. An output signal of the driving controller 46 is input to a gate of the fifth PMOS transistor P5 through the node E. The output driver 47 increases a voltage level of the output node X in response to the output signal of the driving controller 46 and outputs the voltage as the internal voltage INT_VOL.

The precharge block 44 is configured to precharge the nodes A, C and E. The precharge block 44 includes sixth to eighth PMOS transistors P6, P7 and P8. The seventh PMOS transistor P7 is connected between the terminal of the power supply voltage VDD and the node A. The enable signal IN is input to a gate of the seventh PMOS transistor P7. The sixth PMOS transistor P6 is connected between the terminal of the power supply voltage VDD and the node C, and the enable signal IN is input to a gate of the sixth PMOS transistor P6. The eighth PMOS transistor P8 is connected between the terminal of the power supply voltage VDD and the node E, and the enable signal IN is input to a gate of the eighth PMOS transistor P8. When the enable signal IN has a logic low, the sixth to eighth PMOS transistors P6, P7 and P8 turn on to precharge the nodes A, C and E to a voltage level of the power supply voltage VDD.

Assuming that the power supply voltage VDD has a voltage level of 1.8 V and the reference voltage VREF has a voltage level of 0.75, operation of the internal voltage generator 40 will be described hereinafter. When the enable signal IN has a logic low, the nodes A, C and E are precharged to a voltage level of 1.8 V. When the enable signal IN has a logic high to enable the internal voltage generator 40, the voltage comparator 42 is activated and compares the reference voltage VREF with the feedback voltage HALF. If the internal voltage INT_VOL has a voltage level of 1.5 V or less and the feedback voltage HALF has a voltage level of 0.75 V or less, an amount of current flowing to the node A is larger than that flowing to the node C. Subsequently, an amount of current flowing through the fifth NMOS transistor N5 of the driving controller 46 increases. As a result, the voltage level of the node E is lowered. The lowered voltage level of the node E causes the fifth PMOS transistor P5 of the output driver 47 to turn on, and increases the voltage level of the internal voltage INT_VOL.

On the other hand, when the feedback voltage HALF has a voltage level of 0.75 V or more, i.e., when the voltage level of the feedback voltage HALF exceeds that of the reference voltage level VREF, the voltage level of the node C is lowered. Also, the third PMOS transistor P3 turns on. As a result, the node E has an increased voltage level. The increased voltage level of the node E triggers the fifth PMOS transistor P5 to turn off, so that a voltage level of an output node of the internal voltage generator 40 does not increase.

FIG. 3 is a graph of simulation results to describe voltage levels of the internal voltage INT_VOL and the nodes A, B, C, D and E according to the enable signal IN.

The following is assumed to show sectors at which disadvantages may occur when using the conventional internal voltage generator. It is assumed that the enable signal IN has a logic low at an initial operation stage while the feedback voltage HALF has a voltage level greater than the reference voltage VREF, i.e., the voltage level greater than 0.75 V.

With reference to FIGS. 2 and 3, when the enable signal IN has a logic low, the precharge block 44 precharges the nodes A, C and E to a voltage level of 1.8 V. Since the voltage level of the feedback voltage HALF is greater than 0.75 V, the internal voltage INT_VOL maintains a voltage level greater than 1.5 V. When the enable signal IN transits to a logic high from the logic low, the voltage levels of the nodes A and C are lowered. The second PMOS transistor P2 connected to the node A is a diode connected transistor, and thus, the voltage level of the node A decreases to a voltage level of a threshold voltage of the second PMOS transistor P2. After this sector, the node A maintains a consistent voltage level. The voltage level of the node C decreases more slowly than that of the node A because the gate of the first PMOS transistor P1 is connected to the node A. That is, after the enable signal IN transits to a logic high, a sector where the voltage level of the node A is less than the voltage level of the node C exists. At this sector, a large amount of current flows to the fifth NMOS transistor N5, and thus, a voltage level of the node E decreases. Due to this decreasing voltage, the output driver 47 turns on to increase the voltage level of the internal voltage INT_VOL. Even though the internal voltage INT_VOL has a voltage level that is greater than 1.5 V, the internal voltage generator 40 increases the voltage level of the internal voltage INT_VOL. As a result, the internal voltage INT_VOL is more likely to become unstable.

In the conventional internal voltage generator 40, even though the internal voltage INT_VOL has a voltage level greater than a desired voltage level, the output driver 47 operates for a certain period at an initial transition stage of the enable signal IN from a logic low to a logic high. Accordingly, power may be unnecessarily dissipated, and the internal voltage INT_VOL may become unstable.

### SUMMARY OF THE INVENTION

It is, therefore, an object of the present invention to provide an internal voltage generator that can prevent power from unnecessarily supplying to an output node of the internal voltage generator for a certain period at a sector where an enable signal of the internal voltage generator is enabled (i.e., an initial operation stage of a voltage comparator).

In accordance with an aspect of the present invention, there is provided an internal voltage generator, including: a voltage comparator operating in response to an enable signal, comparing a reference voltage with a feedback voltage and outputting a comparison signal through a first node; a driving controller outputting a drive control signal in response to the comparison signal; an output driver outputting an internal voltage through a second node in response to the drive control signal; and an initial operation stabilizer controlling the driving controller for a certain period at which the enable signal is enabled to block an output of the drive control signal.

In accordance with another aspect of the present invention, there is provided an internal voltage generator, including: a voltage comparator operating in response to an enable signal and comparing a reference voltage with a feedback voltage to determine voltage levels corresponding to respective first and second nodes; a driving controller outputting a drive control signal in response to a signal of the first node; an output driver outputting an internal voltage through a third node in response to the drive control signal; a voltage divider dividing the internal voltage output through the third node and then generating the feedback voltage; and an initial operation stabilizer stopping the voltage comparator from performing a comparison operation for a certain period at which the enable signal is enabled.

In accordance with a further aspect of the present invention, there is provided an internal voltage generator, including: an internal voltage generation block operating in response to an enable signal, comparing a reference voltage with a feedback voltage and generating an internal voltage; and an initializer stabilizing the internal voltage generation block in response to the enable signal during an initial operation of the internal voltage generator.

### BRIEF DESCRIPTION OF THE DRAWINGS

The above and other objects and features of the present invention will become better understood with respect to the following description of the exemplary embodiments given in conjunction with the accompanying drawings, in which:

FIG. 1 is a block diagram of a conventional internal voltage generator of a DRAM;

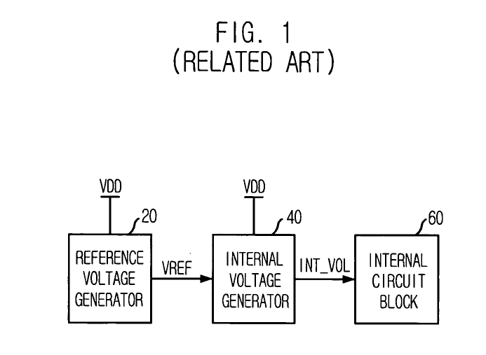

FIG. 2 is a circuit diagram of the conventional internal voltage generator;

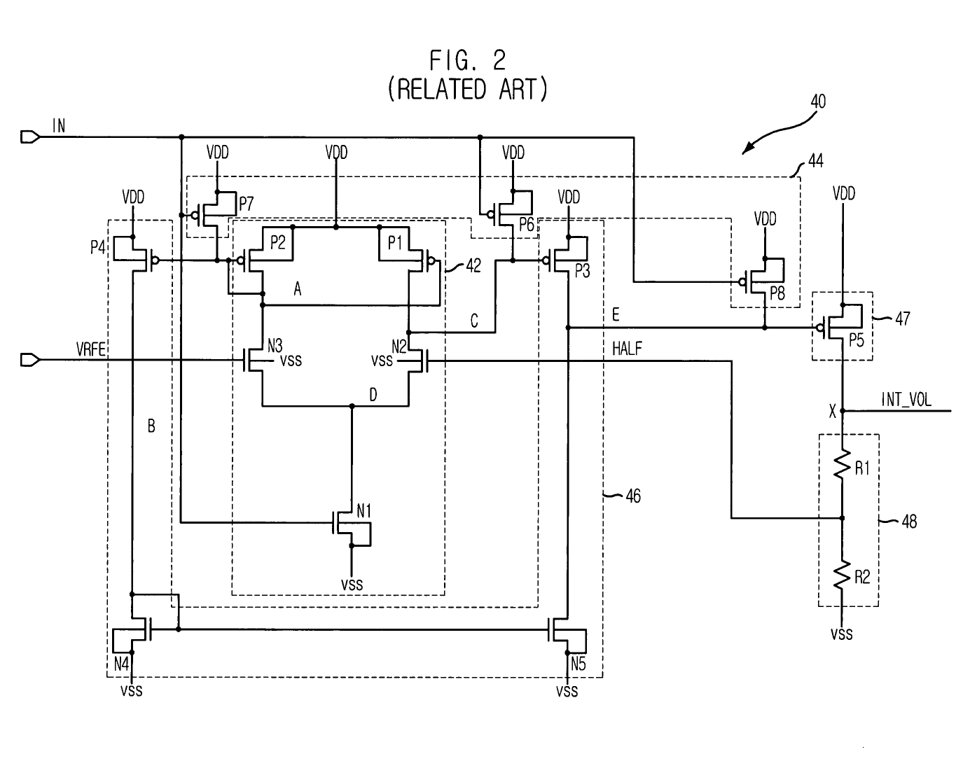

FIG. 3 is a graph of simulation results to describe voltage levels of individual nodes and an internal voltage according to an enable signal in the conventional internal voltage generator;

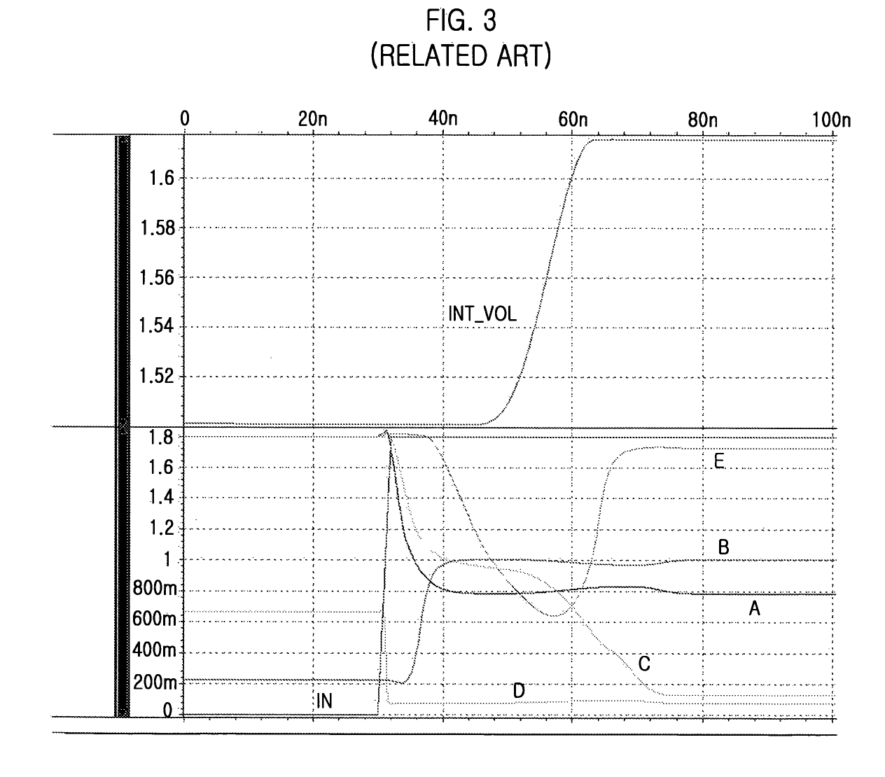

FIG. 4 is a block diagram of an internal voltage generator in a DRAM in accordance with an embodiment of the present invention;

FIG. 5 is a circuit diagram of the internal voltage generator in accordance with the embodiment of the present invention;

FIG. 6 is a graph of simulation results to describe voltage levels of individual nodes, a pulse signal and an internal voltage according to an enable signal according to an embodiment of the present invention; and

FIG. 7 is a circuit diagram of an internal voltage generator in accordance with another embodiment of the present invention.

### DETAILED DESCRIPTION OF THE INVENTION

An internal voltage generator in accordance with various embodiments of the present invention will be described in detail with reference to the accompanying drawings.

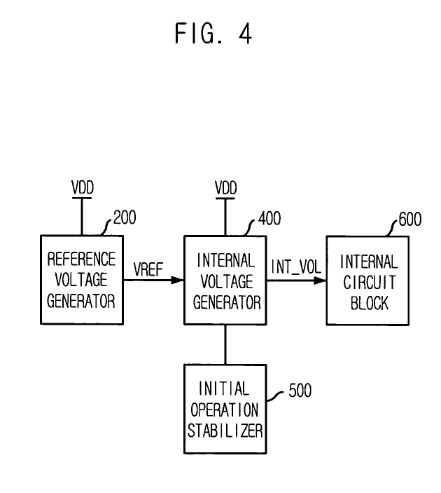

FIG. 4 is a block diagram of an internal voltage generator in a DRAM in accordance with an embodiment of the present invention.

A reference voltage generator 200 is supplied with a power supply voltage VDD and generates a reference voltage VREF having a certain voltage level. The internal voltage generator 400 is supplied with the power supply voltage VDD, the reference voltage VREF, and generates an internal voltage generator INT_VOL. The internal voltage generator INT_VOL is used to operate an internal circuit block 600.

An initial operation stabilizer 500 related to the internal voltage generator 400 according to the present embodiment is described in detail hereinafter.

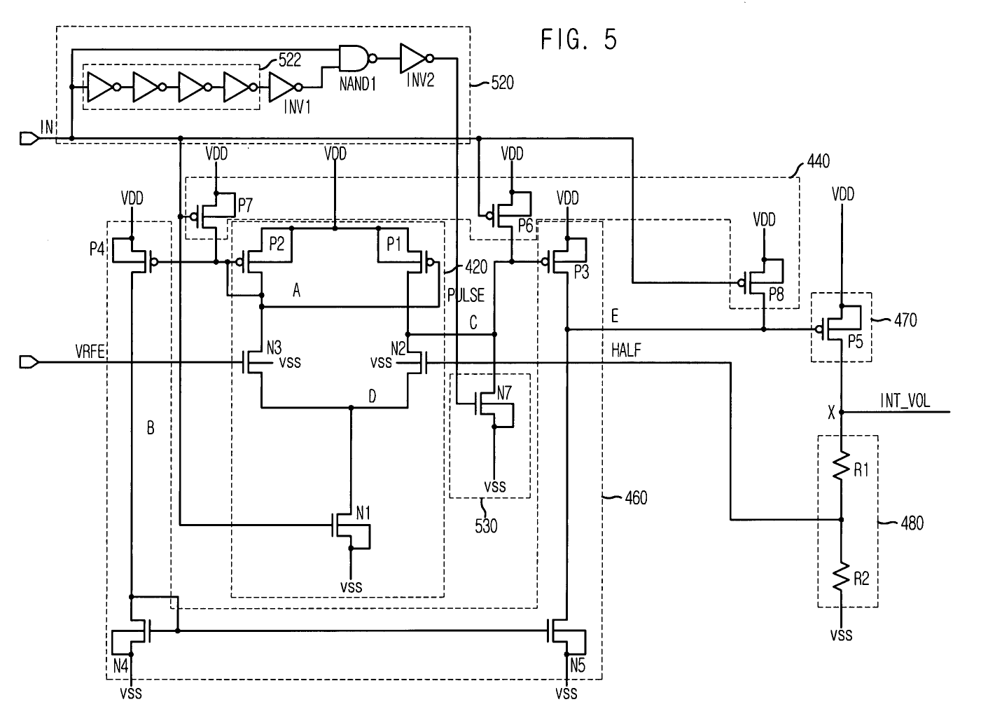

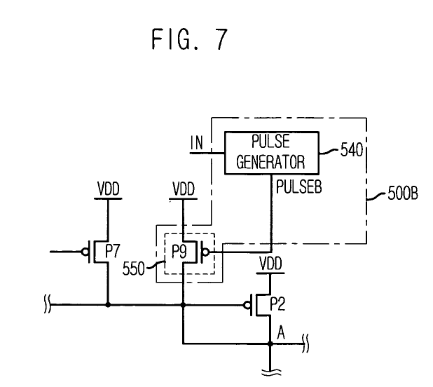

The initial operation stabilizer 500 stabilizes the internal voltage generator 400 in response to an enable signal IN (see FIG. 5) during an initial operation of the internal voltage generator 400. Detailed description of the initial operation stabilizer 500 will be described with reference to FIGS. 5 and 7.

FIG. 5 illustrates a circuit diagram of the internal voltage generator according to an embodiment of the present invention.

The internal voltage generator includes a voltage comparator 420, a precharge block 440, a driving controller 460, an output driver 470, a voltage divider 480, and the initial operation stabilizer 500 (see FIG. 4). The initial operation stabilizer 500 (see FIG. 4) includes a pulse generation block 520 and a stabilization retaining block 530.

The voltage divider 480 is configured to output a feedback voltage HALF, which is a voltage divided from the internal voltage INT_VOL. The voltage divider 480 includes resistors R1 and R2 connected in series. Instead of the resistors R1 and R2, the voltage divider 480 may include metal-oxide semiconductor (MOS) transistors.

The voltage comparator 420, the precharge block 440, the driving controller 460, and an output driver 470 are configured substantially the same as those described above in the background. In the present embodiment, the initial operation stabilizer 500 (see FIG. 4) at a node C outputs an initial stabilization signal to an output node of the voltage comparator 420.

The voltage comparator 420 includes first to third NMOS transistors N1, N2 and N3 and first and second PMOS transistors P1 and P2, which form a current mirror circuit. The first NMOS transistor N1 is connected between a node D and a terminal of a ground voltage VSS, and an enable signal IN is input to a gate of the first NMOS transistor N1. The second NMOS transistor N2 is connected between the node C and the node D, and the feedback voltage HALF is supplied to a gate of the second NMOS transistor N2. The third NMOS transistor N3 is connected between a node A and the node D, and the reference voltage VREF is supplied to a gate of the third NMOS transistor N3. The first PMOS transistor P1 is connected between a terminal of a power supply voltage VDD and the node C, and a gate of the first PMOS transistor P1 is connected to the node A. The second PMOS transistor P2 is connected between the terminal of the power supply voltage VDD and the node A, and a gate of the second PMOS transistor P2 is connected to the node A. The voltage comparator 420 compares the reference voltage VREF with the internal voltage INT_VOL. That is, when a voltage level of the feedback voltage HALF is less than that of the reference voltage VREF, an amount of current flowing to the third NMOS transistor N3 is larger than that flowing to the second NMOS transistor N2. As a result, a voltage level of the node A decreases. In contrast, when the voltage level of the feedback voltage HALF is greater than that of the reference voltage VREF, an amount of current flowing to the second NMOS transistor N2 is larger than that flowing to the third NMOS transistor N3. As a result, a voltage level of the node C decreases. A signal obtained after the comparison is input to the driving controller 460.

The driving controller 460 includes third and fourth PMOS transistors P3 and P4, and fourth and fifth NMOS transistors N4 and N5. The third PMOS transistor P3 is connected between a node E and the terminal of the power supply voltage VDD, and a gate of the third PMOS transistor P3 is connected to the node C. The fourth PMOS transistor P4 is connected between the terminal of the power supply voltage VDD and one terminal of the fourth PMOS transistor P4, and a gate of the fourth PMOS transistor P4 is connected to the node A. The fourth NMOS transistor N4 is connected between another terminal of the fourth PMOS transistor P4 and the terminal B of the ground voltage VSS, and one terminal of the fourth NMOS transistor N4 is connected to a gate thereof. The fifth NMOS transistor N5 is connected between the node E and the terminal of the ground voltage VSS, and a gate of the fifth NMOS transistor N5 is connected to the gate of fourth NMOS transistor N4. The driving controller 460 outputs a signal that controls the output driver 470. If an amount of current flowing through the third NMOS transistor N3 is larger than that flowing through the second NMOS transistor N2, an amount of current flowing through the fourth PMOS transistor P4 and the fourth NMOS transistor N4 increase. Subsequently, an amount of current flowing through the fifth NMOS transistor N5 increases. As a result, a voltage level of the node E decreases. If an amount of current flowing to the second NMOS transistor N2 is larger than that flowing to the third NMOS transistor N3 increases, a voltage level of the node C decreases, the third PMOS transistor P3 turns on. As a result, a voltage level of the node E increases.

The output driver 470 includes a fifth PMOS transistor P5 that is connected between an output terminal X of the internal voltage generator 400 and the terminal of the power supply voltage VDD and has a gate receiving an output signal of the driving controller 460 through the node E.

The precharge block 440 is configured to precharge the voltage levels of the nodes A, C and E. The precharge block 440 includes sixth to eighth PMOS transistors P6, P7 and P8. The sixth PMOS transistor P6 is connected between the terminal of the power supply voltage VDD and the node C, and the enable signal IN is input to a gate of the sixth PMOS transistor P6. The seventh PMOS transistor P7 is connected between the terminal of the power supply voltage VDD and the node A, and the enable signal IN is input to a gate of the seventh PMOS transistor P7. The eighth PMOS transistor P8 is connected between the terminal of the power supply voltage VDD and the node E, and the enable signal IN is input to a gate of the eighth PMOS transistor P8. When the enable signal IN has a logic low, the sixth to eighth PMOS transistors P6, P7 and P8 turn on. As a result, the nodes A, C and E are precharged to the voltage level of the power supply voltage VDD.

The initial operation stabilizer 500 (see FIG. 4) includes a pulse generator 520 and a stabilization retaining block 530. In response to the enable signal IN enabled, the pulse generator 520 generates a pulse signal PULSE having a pulse width substantially as same as a predetermined period. The stabilization retaining block 530 includes a seventh transistor N7. The seventh transistor N7 makes current flow to the terminal of the ground voltage VSS when the pulse signal PULSE is enabled.

The pulse generator 520 includes a delay block 522, a first inverter INV1, a NAND gate NAND1, and a second inverter INV2. The delay block 522 includes even numbers of inverters connected in series. The enable signal IN is input to the delay block 522, which subsequently determines a width of the pulse signal PUlSE. The first inverter INV1 inverts an output signal of the delay block 522. The NAND gate NAND1 receives the enable signal IN and an output signal of the first inverter INV1. The second inverter INV2 inverts an output signal of the NAND gate NAND1 and outputs the pulse signal PULSE. The pulse generator 520 generates the pulse signal PULSE after the enable signal IN is enabled.

The seventh transistor N7 is connected between the node C and the terminal of the ground voltage VSS and has a gate to which the pulse signal PULSE is input. The seventh transistor N7 turns on at the sector where the pulse signal PULSE is enabled by having a logic high. As a result, the seventh transistor N7 sinks the current of the node C to the terminal of the ground voltage VSS.

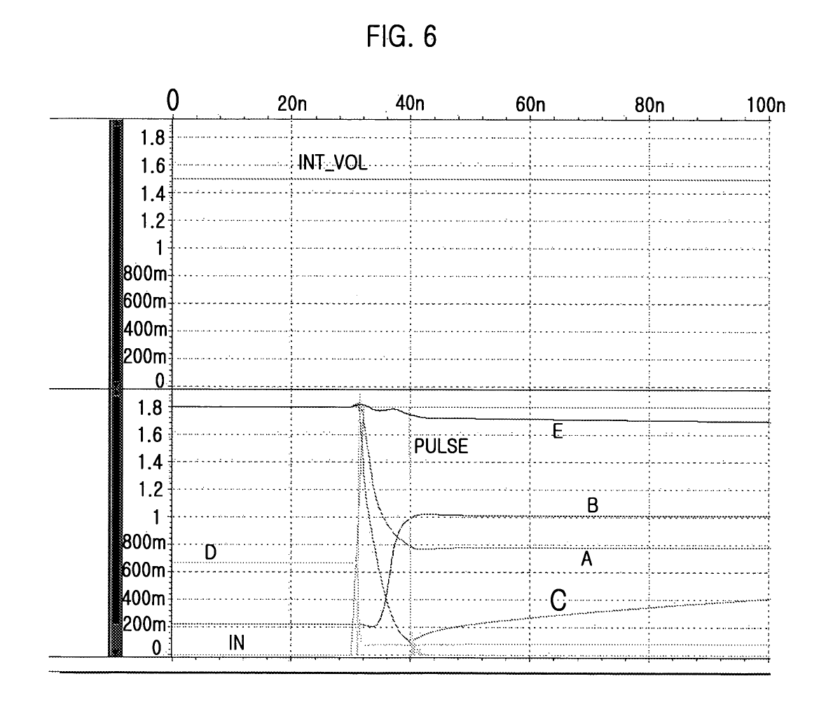

FIG. 6 is a graph of simulation results to describe voltage levels of the individual nodes A to E, the pulse signal PULSE, the internal voltage INT_VOL in accordance with an embodiment of the present invention.

For clarity of the description, the power supply voltage VDD and the reference voltage VREF are assumed to be approximately 1.8 V and approximately 0.75 V, respectively. During an initial operation, the enable signal IN is assumed to initially have a logic low, and the voltage level of the feedback voltage HALF is greater than the voltage level of the reference voltage VREF, i.e., approximately 0.75 V.

When the enable signal IN has a logic low, the precharge block 440 precharges the nodes A, C and E to a voltage level of approximately 1.8 V. If the internal voltage INT_VOL maintains a voltage level greater than approximately 1.5 V, the feedback voltage has a voltage level greater than approximately 0.75 V.

Afterwards, when the enable signal IN transits to a logic high from the logic low, the voltage levels of the nodes A and C are lowered. At this time, the pulse generator 520 generates the pulse signal PULSE that has a logic high for a certain period from a moment that the enable signal IN is enabled. In response to the pulse signal PULSE, the seventh transistor N7 sinks the current of the node C to the terminal of the ground voltage VSS for the predetermined period. As a result, the voltage level of the node C is less than that of the node A.

Due to the lowered voltage level of the node C, the third PMOS transistor P3 of the driving controller 460 turns on, so that the node E maintains the logic high level. The output driver 470 of which gate is connected to the node E retains an off-state, and thus, the internal voltage INT_VOL does not increase to the output terminal X of the internal voltage generator 400.

FIG. 7 is a circuit diagram of an internal voltage generator in accordance with another embodiment of the present invention. Like reference numerals denote like elements described in FIG. 4.

An initial operation stabilizer 500B includes a pulse generator 540 and a stabilization retaining block 550. The pulse generator 540 generates a pulse signal PULSEB that is enabled as a logic low level for a certain period after the enable signal IN is enabled. When the pulse signal PULSEB is enabled as a logic low, the stabilization retaining block 550 pull up the node A to have a logic high. The stabilization retaining block 550 includes a PMOS transistor P9 that is connected between the node A and a terminal of a power supply voltage VDD and has a gate to which the pulse signal PULSEB is input. The pulse signal PULSEB is activated as a logic low and is output at the pulse generator 540. The pulse generator 540 in the present embodiment can be configured by adding an inverter on the output side of the pulse generator 520 according to the first mentioned embodiment of the present invention.

The pulse generator 540 senses a point when the enable signal IN transits from a logic low to a logic high and generates the pulse signal PULSEB that is enabled at the logic low level. The PMOS transistor P9 turns on when the pulse signal PULSEB is enabled at the logic low level, and a voltage level of the node A increases. As a result, the voltage level of the node A becomes greater than that of the node C. That is, because of the stabilization retaining block 550, the voltage comparator 420 (see FIG. 5) stops performing a comparison operation.

With reference to FIG. 6, due to the voltage level of the node C being less than that of the node A, the output driver 470 turns off, and the internal voltage INT_VOL having a voltage level of approximately 1.5 V can be maintained. Thus, power supply is unnecessary.

On the basis of various embodiments, when the internal voltage INT_VOL has a voltage level that is greater than a desired voltage level, the internal voltage generator makes the voltage level of the node C be less than the voltage level of the node A at a point when the enable signal transits from a logic low to a logic high (more particularly, for a certain period of the initial transition sector). As a result, the internal voltage generator can stop the output driver from performing unnecessary operation. Accordingly, unnecessary power supply can be stopped, and the internal voltage can be generated stably.

The present application contains subject matter related to the Korean patent application Nos. KR 2005-0091567 and, 2006-0038699 filed in the Korean Patent Office respectively on, Sep. 29, 2005 and Apr. 28, 2006, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

What is claimed is:

1. An internal voltage generator comprising:
a voltage comparator operating in response to an enable signal, comparing a reference voltage with a feedback voltage and outputting a comparison signal through a first node;
a driving controller outputting a drive control signal in response to the comparison signal;
an output driver outputting an internal voltage through a second node in response to the drive control signal; and
an initial operation stabilizer controlling the driving controller for a certain period at which the enable signal is enabled to block an output of the drive control signal.

2. The internal voltage generator of claim 1, further comprising a voltage divider dividing the internal voltage to generate a feedback voltage.

3. The internal voltage generator of claim 1, where the initial operation stabilizer comprises:
a pulse generator generating a pulse signal enabled for a certain period at which the enable signal is enabled; and
a stabilization retaining block sinking current in response to the pulse signal to block an output of the drive control signal.

4. The internal voltage generator of claim 1, further comprising a precharge block initializing the first node in response to the enable signal.

5. The internal voltage generator of claim 3, wherein the pulse generator generates the pulse signal when the enable signal transits from a logic low to a logic high.

6. The internal voltage generator of claim 5, wherein the pulse generator comprises:
a delay block receiving the enable signal and then determining a width of the pulse signal;
a first inverter inverting an output signal of the delay block;
a NAND gate receiving the enable signal and an output signal of the first inverter; and
a second inverter inverting an output signal of the NAND gate and outputting the pulse signal.

7. The internal voltage generator of claim 6, wherein the delay block comprises an even number of inverters connected in series.

8. The internal voltage generator of claim 3, wherein the stabilization retaining block comprises an N-type channel metal-oxide semiconductor (NMOS) transistor having a gate to which the pulse signal is input and connected between the first node and a ground voltage terminal.

9. The internal voltage generator of claim 1, wherein the voltage comparator comprises:
a first NMOS transistor having a gate to which the enable signal is input and connected between a third node and a ground voltage terminal;
a second NMOS transistor connected between the first node and the third node and having a gate to which the feedback voltage is supplied;
a third NMOS transistor connected between the third node and a fourth node and having a gate to which the reference voltage is supplied;
a first P-type channel metal-oxide semiconductor (PMOS) transistor connected between a power supply voltage terminal and the first node and having a gate connected to the fourth node; and
a second PMOS transistor connected between the fourth node and the power supply voltage terminal and having a gate connected to the fourth node.

10. The internal voltage generator of claim 1, wherein the driving controller comprises:
a first PMOS transistor connected between the ground voltage terminal and a fifth node used to output a signal of the driving controller and having a gate connected to the first node;
a second PMOS transistor having one terminal connected to the power supply voltage terminal and a gate connected to the fourth node;
a first NMOS transistor connected to another terminal of the second PMOS transistor and the ground voltage terminal and having one terminal connected to a gate of the first NMOS transistor; and
a second NMOS transistor connected between the fifth node and the ground voltage terminal and having a gate connected to the gate of the first NMOS transistor.

11. The internal voltage generator of claim 10, wherein the output driver comprises a PMOS transistor having a gate connected to the fifth node, and connected between the power supply voltage terminal and the second node.

12. The internal voltage generator of claim 10, wherein the precharge block comprises:
a first PMOS transistor connected between the power supply voltage terminal and the first node and having a gate to which the enable signal is input;
a second PMOS transistor connected between the power supply voltage terminal and the fourth node; and
a third PMOS transistor connected between the power supply voltage terminal and the fifth node and having a gate to which the enable signal is input.

13. The internal voltage generator of claim 1, wherein the voltage divider comprises first and second resistors connected in series between the second node and the ground voltage terminal, the first and second resistors outputting the feedback voltage through a connection node between the first resistor and the second resistor.

14. The internal voltage generator of claim 13, wherein the first and second resistors include MOS transistors.

15. An internal voltage generator comprising:
a voltage comparator operating in response to an enable signal and comparing a reference voltage with a feedback voltage to determine voltage levels corresponding to respective first and second nodes;
a driving controller outputting a drive control signal in response to a signal of the first node;
an output driver outputting an internal voltage through a third node in response to the drive control signal;
a voltage divider dividing the internal voltage output through the third node and then generating the feedback voltage; and
an initial operation stabilizer stopping the voltage comparator from performing a comparison operation for a certain period at which the enable signal is enabled.

16. The internal voltage generator of claim 15, wherein the initial operation stabilizer comprises:
a pulse generator generating a pulse signal enabled for a certain period at which the enable signal is enabled; and
a stabilization retaining block stopping the voltage comparator from performing a comparison operation in response to the pulse signal.

17. The internal voltage generator of claim 15, further comprising a precharge block initializing the first and second nodes in response to the enable signal.

18. The internal voltage generator of claim 16, wherein the pulse generator generates the pulse signal when the enable signal transits from a logic low to a logic high.

19. The internal voltage generator of claim 16, wherein the pulse signal is enabled at a logic low.

20. The internal voltage generator of claim 16, wherein the stabilization retaining block includes a PMOS transistor having a gate to which the pulse signal is input and connected between a power supply voltage terminal and the second node.

21. The internal voltage generator of claim 15, wherein the voltage comparator comprises:
a first NMOS transistor having a gate to which the enable signal is input and connected between a fourth node and a ground voltage terminal;
a second NMOS transistor connected between the first node and the fourth node and having a gate to which the feedback voltage is supplied;
a third NMOS transistor connected between the second node and the fourth node and having a gate to which the reference voltage is supplied;
a first P-type channel metal-oxide semiconductor (PMOS) transistor connected between a power supply voltage terminal and the first node and having a gate connected to the second node; and
a second PMOS transistor connected between the second node and the power supply voltage terminal and having a gate connected to the second node.

22. The internal voltage generator of claim 15, wherein the driving controller comprises:
a first PMOS transistor connected between the ground voltage terminal and a fifth node used to output a signal of the driving controller and having a gate connected to the first node;
a second PMOS transistor having one terminal connected to the power supply voltage terminal and a gate connected to the second node;
a first NMOS transistor connected to another terminal of the second PMOS transistor and the ground voltage terminal and having one terminal connected to a gate of the first NMOS transistor; and
a second NMOS transistor connected between the fifth node and the ground voltage terminal and having a gate connected to the gate of the first NMOS transistor.

23. The internal voltage generator of claim 22, wherein the output driver comprises a PMOS transistor having a gate connected to the fifth node, and connected between the power supply voltage terminal and the third node.

24. The internal voltage generator of claim 22, wherein the precharge block comprises:
a first PMOS transistor connected between the power supply voltage terminal and the first node and having a gate to which the enable signal is input;
a second PMOS transistor connected between the power supply voltage terminal and the second node and having a gate to which the enable signal is input; and
a third PMOS transistor connected between the power supply voltage terminal and the fifth node and having a gate to which the enable signal is input.

25. The internal voltage generator of claim 15, wherein the voltage divider comprises first and second resistors connected in series between the third node and the ground voltage terminal, the first and second resistors outputting the feedback voltage through a connection node between the first resistor and the second resistor.

26. The internal voltage generator of claim 25, wherein the first and second resistors include MOS transistors.

27. An internal voltage generator comprising:
an internal voltage generation block operating in response to an enable signal, comparing a reference voltage with a feedback voltage and generating an internal voltage; and
an initializer stabilizing the internal voltage generation block in response to the enable signal during an initial operation of the internal voltage generator.

28. The internal voltage generator of claim 27, wherein the initializer senses a point when the enable signal is enabled and performs stabilizing operation for the internal voltage generation block.
